(19) United States
(12) Patent Application Publication
(10) Pub. No.: US 2005/0117844 A1
(43) Pub. Date: Jun. 2, 2005

(54) Method and system for coupling waveguides

(76) Inventors: Joseph Abeles, East Brunswick, NJ (US); David Capewell, Brown Mills, NJ (US); Lou DiMarco, Mercer County, NJ (US); Martin Kwakernaak, New Brunswick, NJ (US); Nagendranath Maley, Exton, PA (US); Hooman Mohseni, Princeton, NJ (US); Ralph Whaley, Princeton Junction, NJ (US); Liyou Yang, Plainsboro, NJ (US)

Correspondence Address: Jonathan M. Darcy;Reed Smith LLP, 2500 One Liberty Place, 1650 Market Street, Philadelphia, PA, 19103, US

(21) Appl. No.: 10/831,535

(22) Filed: Apr. 23, 2004

Related U.S. Application Data
(60) Provisional application No. 60/464,763, filed on Apr. 23, 2003.

(51) Int. Cl. G02B 6/26

(52) U.S. Cl. 385/39; 385/14

(57) ABSTRACT

A method for photonically coupling to at least one active photonic device structure formed on a substrate, the method including: etching the active device structure with a high selectivity towards a crystallographic plane to form a sloped terminice with respect to the substrate; and, depositing at least one waveguide over the etched terminice and at least a portion of the substrate; wherein, the waveguide is photonically coupled to the etched active device structure to provide photonic interconnectivity for the etched active device structure.

### RELATED APPLICATION

This application claims priority of U.S. Patent Application Ser. No. 60/464,763, entitled “MULTIPLE LAYER WAVEGUIDE STRUCTURES FOR A-SI BASED PHOTONIC INTEGRATED CIRCUITS, SLOPED COUPLING JOINT IN A-SI BASED PHOTONIC INTEGRATED CIRCUITS AND CIRCUITS INCLUDING SAME”, filed Apr. 23, 2003, the entire disclosure of which is hereby incorporated by reference as if being set forth in its entirety herein.

### FIELD OF INVENTION

The present invention relates to waveguide coupling techniques, such as those used in connection with photonic integrated circuits.

### BACKGROUND OF THE INVENTION

Widespread development and proliferation of Photonic Integrated Circuits (PICs) including active components, such as III-V semiconductor photonic devices like lasers and modulators, and passive components, such as passive waveguides, are believed highly desirable. Such circuits and devices may be monolithic in nature. One challenge in developing such PICs lies in integrating both active and passive components, and operationally coupling them to one-another. This may result from using different materials, having different indices of refraction for example, in active and passive components.

One approach may include butt coupling the active and passive devices together. However, this may conventionally require precise alignment of the active and passive devices to achieve desired coupling efficiencies.

Accordingly, a method and system that provides for improved coupling of active and passive photonic devices together, such as in a PIC by way of non-limiting example only, is believed desirable.

### SUMMARY OF THE INVENTION

A method for photonically coupling to at least one active photonic device structure formed on a substrate, the method including: etching the active device structure with a high selectivity towards a crystallographic plane to form a sloped terminice with respect to the substrate; and, depositing at least one waveguide over the etched terminice and at least a portion of the substrate; wherein, the waveguide is photonically coupled to the etched active device structure to provide photonic interconnectivity for the etched active device structure.

### BRIEF DESCRIPTION OF THE FIGURES

Understanding of the present invention will be facilitated by consideration of the following detailed description of the preferred embodiments taken in conjunction with the accompanying drawings, in which like numerals refer to like parts, and:

FIG. 1 illustrates three and two layer waveguide coupling joints according to aspects of the present invention;

FIG. 2 illustrates vertical (illustration a) and sloped (illustration b) active/passive junctions or interfaces according to aspects of the present invention;

FIG. 3 illustrates an active/passive junction at various processing steps according to an aspect of the present invention;

FIG. 4 illustrates SEM micrographs of the semiconductor step edge produced by a non-selective wet chemical etch and a flat area in a channel, according to an aspect of the present invention;

FIG. 5 illustrates an SEM image of a coupling joint fabricated using a selective wet etch according to an aspect of the present invention;

FIG. 6 illustrates an SEM image of a coupling joint fabricated using a combination of selective and non-selective wet etches according to an aspect of the present invention;

FIG. 7 illustrates a coupling joint profile from a wet and dry etch sequence, according to an aspect of the present invention; and,

FIG. 8 illustrates a coupling joint of a device after an a-Si deposition and etch, according to an aspect of the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical PICS, active devices, passive devices and coupling methods. Those of ordinary skill in the art will recognize that other elements may be desirable in implementing the present invention. However, because such elements are well known in the art, and because they do not facilitate a better understanding of the present invention, a discussion of such elements is not provided herein. The disclosure herein is directed to all such variations and modifications known to those skilled in the art.

According to an aspect of the present invention, amorphous silicon (a-Si) based waveguides may be used for Photonic Integrated Circuit (PIC) integration. A two layer structure may be used to reduce losses at active/passive device coupling joints and may be simpler to manufacture than a three layer structure.

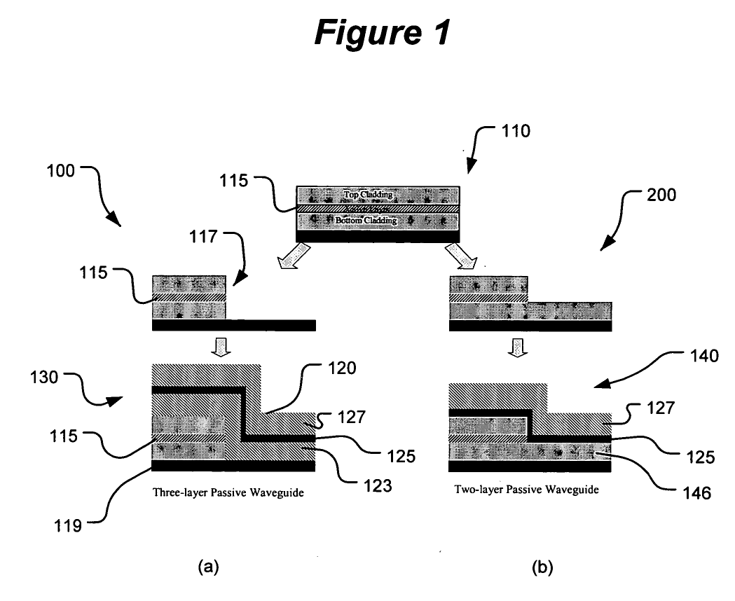

Referring now to FIG. 1, there are shown a three layer coupling system 100 for an active device 110 and passive waveguide 120 (illustration a), and a two layer coupling system 200 for an active device 110 and passive waveguide 120 (illustration b).

Active device 110 may take the form of any suitable active device, such as a bulk semiconductor, quantum well or quantum dot based device, by way of non-limiting example only. Such a device may be characterized as having long wavelength operational characteristics, for example. Such a device may incorporate III-V semiconductor materials for example. Such a device may incorporate GaAs or InGaAs materials, for example. Such a device may form a laser, or portion thereof, a modulator, or portion thereof, or a gain section for a larger system, all by way of non-limiting example only. Device 110 may have a core 115, as will be readily understood by those possessing an ordinary skill in the pertinent arts. Device 110 may have one or more terminices 117 that are desirable to have one or more waveguides 120 operationally coupled to. FIG. 1 illustrates a single terminice 117 and waveguide 120 for purposes of illustration only.

According to an aspect of the present invention, waveguide 120 may include upper cladding layer 127 and an active layer 125. According to an aspect of the present invention, waveguide 120 may optionally include a lower cladding 123. According to an aspect of the present invention, upper cladding 123, core 125, and lower cladding 127 may take the form of an a-Si based material such as a-SiNxHy (0<x<1.3, 0<y<0.3), a-SiCxHy (0<x<1, 0<y<0.3), or a-SiOxHy (0<x<1, 0<y<0.3). The desired refractive index for the upper cladding 123, core 125, and lower cladding 127 may be achieved by adjusting the composition of the a-Si based material. The upper and lower cladding layers may have an index of refraction around 3.17. The core may have an index of refraction between around 3.27 and around 3.32. Layers 127, 125 may be of any suitable thickness, such as about 1 μm for layer 127, and about 0.3 μm for layer 125. Layer 123, if present, may have any suitable thickness as well, such as about 1 μm, by way of non-limiting example only.

Illustration (a) shows a three-layer passive waveguide 130 including layer 123, while illustration (b) shows a two-layer passive waveguide 140 omitting layer 123. In either case, a suitable substrate, such as an In-P substrate of suitable thickness, such as about 0.35 mm thick, may be used. Such a substrate may have in index of refraction around 3.17, for example. In the case of a 2-layer waveguide configuration, such as that shown in illustration (b), one or more layers in common with active device 110 and/or the substrate may be used to at least partially clad or confine the passive waveguide 140 core.

Active device 110 may be formed using conventional methodologies. For example, device 110 may be formed by first depositing a stack of quaternary layers upon a conventional InP substrate. The stack may form the active layer of the device and include alternating 95 nm thick InGaAs and InGaAsP layers. For example, five layers may be provided. A 635 nm thick InP spacing/blocking layer may then be deposited upon the active layer. A 30 nm thick InGaAsP etch stop layer may then be deposited. A 1300 nm InP layer may then be deposited. And, finally a 50 nm thick InGaAs cap may be deposited. Deposition of the layers may be accomplished in conventional manners, such as by using liquid or plasma enhanced chemical vapor deposition, for example.

Waveguides 130, 140 may be positioned with respect to device 110, such that the core 115, or active layers, of device 110 is operationally coupled to the cores 125 of waveguides 130, 140, respectively.

For example, and with regard to illustration (a) of FIG. 1, a lower cladding 123 may have a suitable thickness for elevating core 125 above substrate 119 to a level substantially aligned with core 115. With regard to illustration (b), one or more layers 146 common to and used to form or support part of device 110 may be used analogously.

As will be understood by those possessing an ordinary skill in the pertinent arts, waveguide 130 may present several disadvantages compared to waveguide 140. First, the deposition of the amorphous silicon material on the sidewalls of device 110, i.e., terminice 117, may prove more difficult in the three-layer structure, since a layer of low-index material is included between the active and passive low-index layers. Second, the alignment of the passive and active waveguide cores may prove more challenging in a three-layer scheme, since the thickness of the passive bottom-cladding layer may be significantly more than alignment tolerances. And third, the overall thickness of the amorphous silicon may be considerably higher in the three-layer scheme, which can lead to more peeling and/or cracking problems in the presence of a relatively small stress, for example.

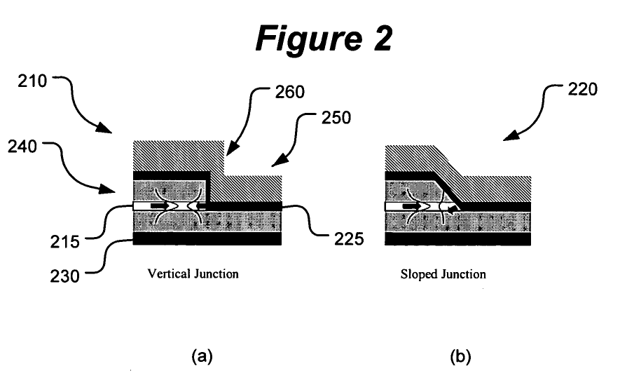

According to an aspect of the present invention, interfaces between active and passive components of a PIC may have sloped regions. Referring now also to FIG. 2, there are shown vertical (illustration a) and sloped (illustration b), active/passive junctions or interfaces 210, 220. Sloped coupling joints, such as that shown in illustration (b), may reduce residual interface reflection in a-Si waveguide based photonic integrated circuits, thus improving device performance. A vertical junction, such as that shown in illustration (a), may tend to produce more significant back reflections for a given effective index mismatch between the active and passive waveguides. This back reflection can result in significant interference and losses, which can deteriorate the performance of optical devices such as semiconductor optical amplifiers (SOA) and super luminescence diodes (SLD), by way of non-limiting example only. This risk may be at least partially mitigated by suppressing reflections using a sloped active-passive junction, since the average change of index may be less in such a structure and the back reflection is not directed at the waveguide. The slope of the sloped junction may align with and be dependent upon a crystallographic plane of material incorporated into the active device being coupled to, for example.

Referring still to FIG. 2, each of systems 210, 220 may be based upon the two layer coupling structure 140 of FIG. 1. More particularly, each system 210, 220 may include a substrate 230. Substrate 230 may take the form of an approximately 0.35 mm thick InP substrate having an index of refraction of about 3.17, for example. Each system 210, 220 may include an active device region 240 and passive waveguiding region 250. Region 240 may be analogous to active device 110 of FIG. 1, while region 250 may be analogous to waveguide 140 of FIG. 1. Undesirable reflections due to interface region 260 may be reduced in the sloped system 220 as compared to vertical system 210, due, at least in part, to residual interface reflections associated with region 260 not being aligned with a core 215 of active region 240 or core 225 of waveguide region 250.

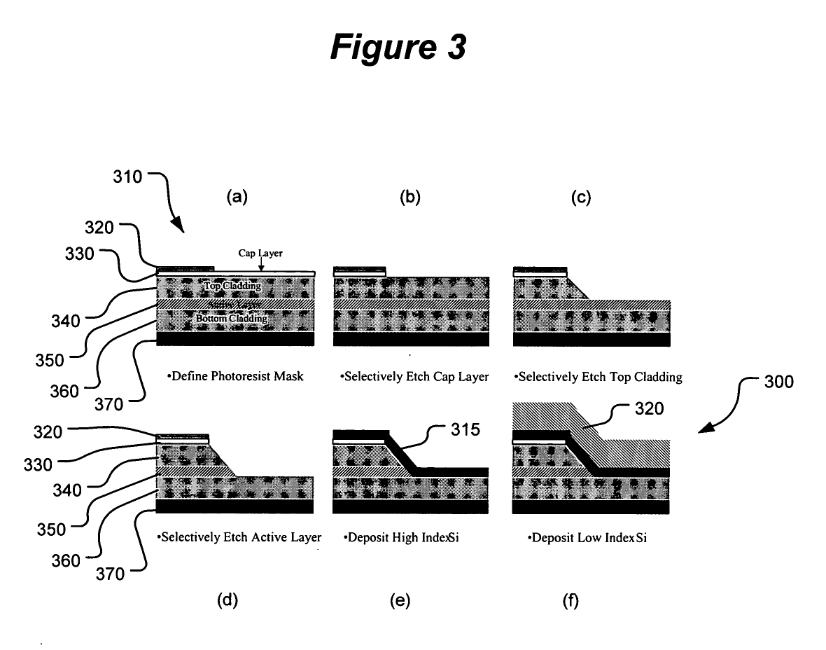

Referring now also to FIG. 3, there is shown an active/passive junction 300 at various processing steps (a)-(f) according to aspects of the present invention. Junction 300 may take a form analogous to that of system 220, for example.

According to an aspect of the present invention, a wet-based chemical etching method may be used to produce active-passive junctions with a high uniformity and reproducibility of the slope angle and total etch depth. According to an aspect of the present invention, junction position and shape may be defined using conventional photolithographic techniques. This is illustrated in step (a), wherein system 310 is shown to include a protective layer 320, cap layer 330, top cladding 340, active layer(s) 350, bottom cladding 360 and substrate 370. In such a case, protective layer 320 may take the form of a photoresist mask for use in further processing, for example. System 310 may define an active device, such as a laser, SOA or SLD structure, for example.

Referring now also to step (b), cap layer 320 may then be selectively removed, such as by etching for example. Referring now also to step (c), top cladding layer 330 may then be etched with a high selectivity towards a crystallographic plane. This may serve to provide a reproducible slope while etch depth uniformity is also ensured by the active layer providing etch stop functionality. Active layer(s) 340 may then be removed selectively, again using conventional methodologies for example, as is illustrated in step (d). As is shown in step (e), a high-index amorphous silicon, which serves as waveguiding core 315, may then be deposited onto the etched system 310. It may be noted that the slope may also serve to reduce void formation at the corner of the active material. Finally, as is shown in step (f), a low-index amorphous silicon, which forms top cladding layer 320 of the passive waveguide, may be deposited in a conventional manner, for example.

In general, and by way of non-limiting example only, several methods for forming a sloped coupling joint are presented. A nominal 1550 nm emitting wavelength wafer that includes a 5-quantum well quaternary stack of 95 nm thick layers were considered. Sections of the wafer were defined with 200 micron openings on 800 micron spacing (mesas) and 400 micron openings on 600 micron spacing using photolithography. Several etching experiments were performed on these wafer sections to fabricate a deep groove defined in the resist openings through the laser active layer. These grooves were subsequently used for amorphous silicon waveguide deposition.

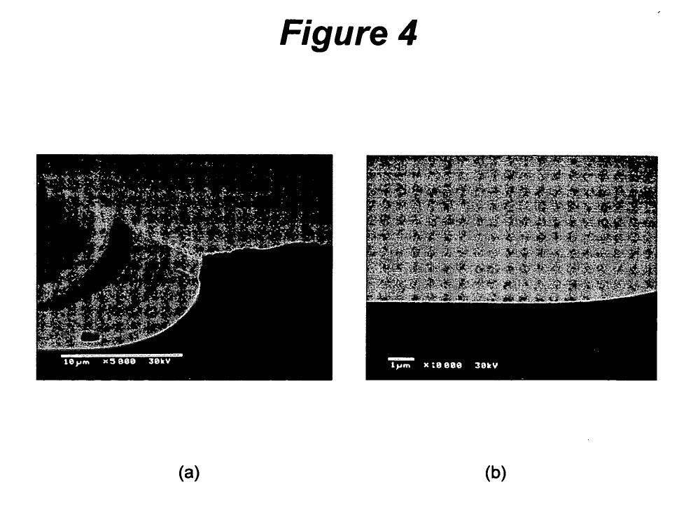

According to an aspect of the present invention, a wet chemical etching of the grooves with a non-selective bromine/acetic acid etch may be used. This etch may have substantially no selectivity to the various layers of the active device structure, such that it does not stop at different chemical compositions in the structure, for example. Referring now also to FIG. 4, there are shown SEM micrographs of the etched edge surface with a sloped profile (a) and the flat area in the channel (b). The resulting groove profiles were rounded and smooth. One potential problem with the non-selective etch is that etch depth may be difficult to control.

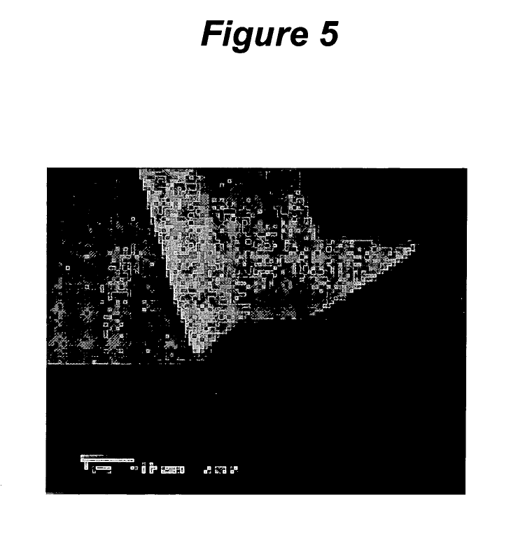

According to an aspect of the present invention, selective etches known to stop at different chemical compositions in a laser structure may be chosen as opposed to a non-selective etch. For example, Caro's acid, a mixture of sulfuric acid, hydrogen peroxide, and water, may be used to selectively remove a 50 nm indium gallium arsenide (InGaAs) cap to reveal the underlying indium phosphide (InP) cladding layer. The 1300 nm InP layer may then be etched using a hydrochloric acid, phosphoric acid solution to a 30 nm quaternary (InGaAsP) etch stop layer which may then be selectively removed with Caro's acid. 635 nm spacer/blocking layers may then be removed with the HCl-phosphoric acid etch to the remaining 95 nm quaternary active layers. It may be noted however, that etching of the active layers with Caro's acid may result in undercutting of the layer that may be difficult to avoid. Referring now also to FIG. 5, there is shown a coupling joint fabricated using the selective wet etch procedure described. Undercutting of the quaternary structure is evident.

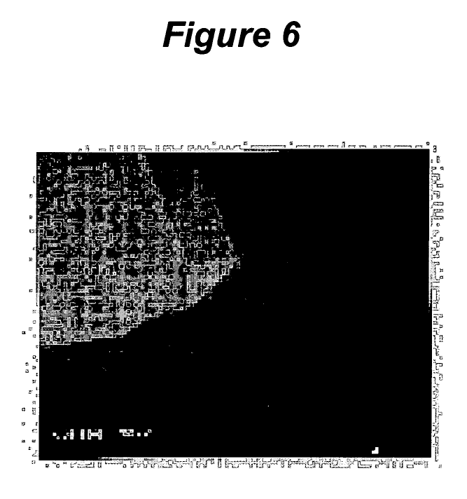

According to an aspect of the present invention, a combination of selective and non-selective etching may be used. Such a method may involve the same selective etching explained above where selective etches were employed to remove the grown layers and terminating at the top of the 95 nm quaternary active layer stack. According to an aspect of the present invention, the active layers may be non-selectively removed with a dilute bromine solution to the n-clad InP layer. This combination of selective-non-selective etches may serve to produce an acceptable profile with smooth surfaces without undercutting the active layers associated with other methods discussed herein. Referring now also to FIG. 6, there is shown a coupling joint fabricated by the combination of selective and non-selective etches.

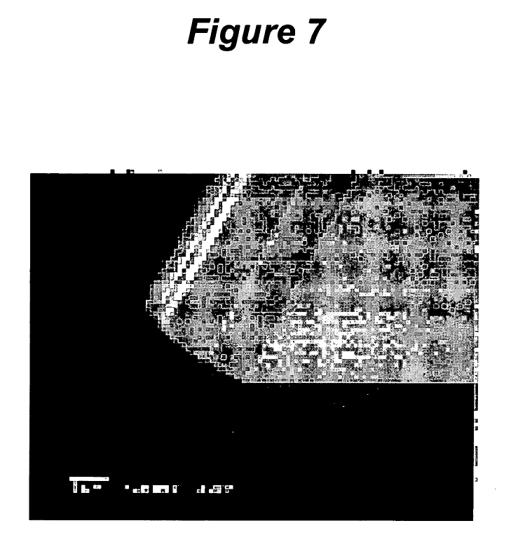

According to an aspect of the present invention, a combination of wet and dry etches may be used. By replacing the selective wet etch for the etch stop layer with a non-selective dry etch, one may substantially eliminate large plateaus in the joint profile. By doing so, one may eliminate significant undercut of the cap layer at top of the device which may cause formation of the plateau during subsequent selective wet etching of InP. Referring now also to FIG. 7, there is shown a coupling joint profile from the modified etch sequence.

By way of further non-limiting example only, a suitable resist, such as 1813 resist, may be spun and prebaked onto the subject wafer, such as by spinning at 4500 RPM for 30 seconds and then prebaking at 90 degrees Celsius on a hotplate, for example. The thickness and index of the film may be checked with an ellipsometer, for example. The prebaked mask material may then be exposed, such as for about 5 seconds, such as by exposing the mask material to 365 nm i-line contact photolithography. The exposed mask material may then be developed, such as by using a 4/1H₂O/Shipley AZ 351 developer for about 35 seconds, for example. The developed mask may then be postbaked, such as for about 2 minutes using a 90 degrees Celsius hotplate, for example. According to an aspect of the present invention, the masked wafer may be cleaned, using an O₂ plasma for about 3 minutes at 125 watts, for example. This may largely correspond to step (a) of FIG. 3.

Again by way of non-limiting example only, where a silicon nitride cap layer is used, it may be etched for about 1 minute at about 100 W—50 cc with DE101 plasma, composed of CF₄, He, and O₂. The resist may then be stripped in acetone and treated with O₂ plasma for about 2 minutes, for example. The thickness of the Si₃N₄ cap may be checked with a profilometer. This may correspond to step (b) of FIG. 3.

By way of non-limiting further example only, the trench may be wet etched to an etch-stop layer using 10-1-1 Caro's acid for about 30 sec and 80% 3/1 HCL/H₃PO₄ at about 5 degrees Celsius for about 2 minutes. This may correspond to step (c) of FIG. 3.

Next, the etch stop layer may be dry etched, such as by using 4.4 sccm Ar, 11 sccm CH₄, 30 sccm H₂, at about 20 mtorr—250 W for about 2 minutes, 45 seconds for example. Next, the trench may be etched to the confinement layer using the HCL/phosphoric solution. The quantum well stack may be dry etched to the top of the N clad, such as by using 4.4 sccm Ar, 11 sccm CH₄, 30 sccm H₂, at about 20 mtorr—250 W for about 19 minutes, 30 seconds. Sequential measurements may be effectively used. Finally, one may strip remaining nitride in buffered HF for about 2 minutes, check the surface, and dip in 20/1H₂O/NH₄OH for about 15 seconds. This may largely correspond to step (d) of FIG. 3.

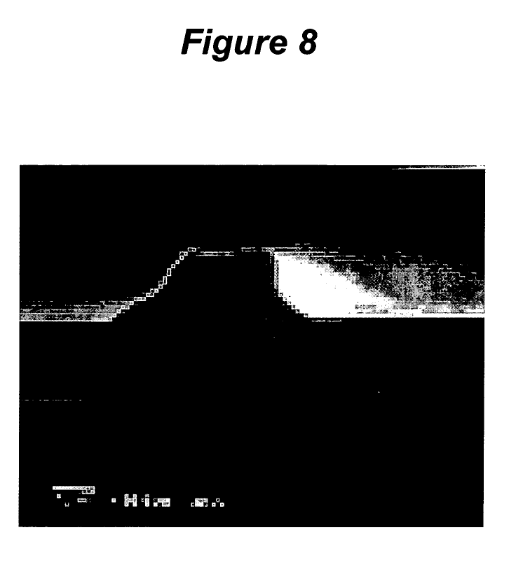

After the etching steps, an a-Si waveguide structure may be deposited over the joint region to form an active/passive coupling, as is shown in step (e) of FIG. 3. Such deposition may be accomplished using any suitable conventional manner, such as sputtering or plasma enhanced chemical vapor deposition, both by way of non-limiting example only. An example of such a coupling joint is shown in FIG. 8.

It will be apparent to those skilled in the art that various modifications and variations may be made in the apparatus and process of the present invention without departing from the spirit or scope of the invention. Thus, it is intended that the present invention cover the modification and variations of this invention provided they come within the scope of the appended claims and their equivalents.

1. A method for photonically coupling to at least one active photonic device structure formed on a substrate, said method comprising:
etching said active device structure with a high selectivity towards a crystallographic plane to form a sloped terminice with respect to said substrate; and,
depositing at least one waveguide over said etched terminice and at least a portion of said substrate;
wherein, said waveguide is photonically coupled to said etched active device structure to provide photonic interconnectivity for said etched active device structure.

2. The method of claim 1, wherein said substrate and waveguide are positioned such that said substrate provides confinement for said waveguide.

3. The method of claim 1, wherein said active device structure comprises a plurality of layers, and at least one of said layers is common to said active device structure and said waveguide.

4. The method of claim 3, wherein said at least one of said layers comprises a lower confinement layer.

5. The method of claim 4, wherein said waveguide consists of a waveguiding core and upper cladding layer.

6. The method of claim 1, wherein said waveguide comprises at least one amorphous silicon material.

7. The method of claim 6, wherein said material comprises at least one material selected from the group consisting essentially of a-SiNxHy (0<x<1.3, 0<y<0.3), a-SiCxHy (0<x<1, 0<y<0.3), or a-SiOxHy (0<x<1, 0<y<0.3).

8. The method of claim 1, wherein said active device structure forms at least one device selected from the group consisting of a laser, a light emitting diode, a super luminescent diode, a modulator, a gain section, and an amplifier.

9. The method of claim 1, further comprising spin coating a photoresist onto said active device structure.

10. The method of claim 1, wherein said etching comprises wet etching a top cladding using Caro's acid.

11. The method of claim 10, wherein said etching further comprises wet etching said top cladding using HCL and H₃PO₄.

12. The method of claim 11, wherein said etching further comprises dry etching at least one active layer.

13. The method of claim 12, wherein said dry etching comprises using Ar, CH₄ and H₂.

14. The method of claim 13, wherein a ratio of Ar, CH₄ and H₂ used is about 4.4:11:30.

15. The method of claim 1, wherein said waveguide comprises at least a-si:H based alloy.

16. A photonic integrated circuit comprising:
at least one active photonic device; and,
at least one waveguide photonically coupled to said at least one active photonic device;
wherein, said at least one waveguide consists of an amorphous silicon alloy based core and an amorphous silicon alloy based upper cladding.

17. A photonic integrated circuit comprising:
a substrate;
a plurality of layers on said substrate and forming at least one active photonic device; and,
at least one waveguide photonically coupled to said at least one active photonic device;
wherein, said at least one waveguide comprises at least one of said plurality of layers forming at least one active photonic device.

18. A photonic device comprising:
a substrate:
at least one active photonic structure formed on said substrate and having at least one terminice being sloped with respect to said substrate; and,
at least one waveguide coupled to said sloped terminice and over at least a portion of said substrate.

19. The device of claim 18, wherein said active structure forms at least one device selected from the group consisting of a laser, a light emitting diode, a super luminescent diode, a modulator, a gain section, and an amplifier.

20. The device of claim 18, wherein said slope is associated with a crystallographic plane of at least one of said layers.

21. The device of claim 18, wherein at lest one of said layers provides a lower confinement layer for said at least one waveguide.
